(19) United States
(12) Patent Application Publication
(10) Pub. No.: US 2008/0262653 A1
(43) Pub. Date: Oct. 23, 2008

(54) Parallel Robot Comprising Assembly for Moving a Mobile Element Composed of Two Subassemblies

(76) Inventors: Vigen Arakelyan, Rennes (FR); Patrick Maurine, Orgeres (FR); Sebastien Briot, Pont-Rean (FR); Emmanuel Pion, Saint-Sauveur (FR)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/658,115

(22) PCT Filed: May 30, 2005
(86) PCT No.: PCT/FR2005/001326

§ 371 Date: May 8, 2008

(30) Foreign Application Priority Data
Jul. 22, 2004 (FR) 0408151

(51) Int. Cl. G06F 19/00; B25J 17/02; B66F 9/06

(52) U.S. Cl. 700/245; 414/680; 901/1

(57) ABSTRACT

The disclosure concerns a robot of the type including a base element and a mobile element coupled to the base element through an element for triggering movement. The movement-triggering element includes first and second subassemblies. The first assembly is designed to move the mobile element along a substantially vertical direction. The second subassembly connects the first subassembly to the mobile element and includes at least three actuators capable of acting in parallel to move the mobile element in a substantially horizontal plane independently of the first subassembly.

### CROSS-REFERENCE TO RELATED APPLICATION

This Application is a Section 371 National Stage Application of International Application No. PCT/FR2005/001326, filed May 30, 2005 and published as WO 2006/021629 on Mar. 2, 2006, not in English.

### FIELD OF THE DISCLOSURE

The domain of the disclosure is automatic manipulators. More precisely, the disclosure relates to a so-called parallel robot.

### BACKGROUND

Industrial robots are classified into two main groups: serial robots and parallel robots.

The mobile structure of serial robots is an open chain formed from a sequence of segments connected together with connections with a single degree of freedom. Each articulation is controlled by an actuator located at the articulation or on one of the previous segments. In the latter case, a mechanism controls transmission between the actuator and the articulation considered.

Such a configuration requires a heavy structure because large masses have to be put into movement, even when displacing a small load.

Parallel robots may be defined as being mechanical systems with several degrees of freedom composed of two rigid bodies connected together by one or several loops forming a plane polygon.

Parallel robots have many advantages compared with serial robots: high speed movements and particularly high accelerations, a more uniform distribution of loads on the actuators, higher mechanical stiffness and small moving mass that significantly improves the dynamic capacity of the robot.

The disadvantages of parallel robots include a restricted working volume imposed by the very design of the robot, the presence of singularities in the working volume and strong coupling between the movement of the different kinematic systems. Coupling of movements raised difficulties in determining differential models. For example, the motor increment depends on the position of the robot, and will be smaller as the robot moves towards the centre; this phenomenon introduces a variable inertia that is difficult to manage while maintaining high operating speeds.

Parallel robot applications have not stopped increasing during the last twenty years; these robots are used in the food processing, pharmaceutical, aeronautical industries, etc. They are increasingly used in industry for the design of new generations of machine tools.

Most known robots of the above type, for example such as the Delta (registered trademark) robot disclosed in the patent document published as U.S. Pat. No. 4,976,582, includes a base element and a mobile element, and three control arms mounted rigidly at their first end on three hinge points that may be rotated. The other end of each control arm is rigidly fixed to the mobile element through two connecting bars installed in an articulation, firstly on the second end of the control arm and secondly on the mobile element.

According to this technique, the inclination and the orientation of the mobile element in space remain unchanged, regardless of the movements of the three control arms.

The mobile element supports a working element for which rotation is controlled by a motor fixed on the base element. A telescopic arm connects the motor to the working element.

Such a robot has four degrees of freedom. It controls the three movements of the mobile element and rotation of the working element.

However, a robot of this type is not well adapted for precise transfer of heavy parts because the controls of the mobile element are coupled together.

This means that to move the mobile element along a direction, all motors have to be activated simultaneously and robot controls have to be connected together.

In other words, it is impossible for such a robot to activate a single motor to move the mobile element in a single direction. Consequently, such a system is difficult to control because the controls have to be synchronised. Also, the dynamic representation of the robot is based on a system of non-linear coupled differential equations. The result is that controls do not integrate non-linear phenomena related to system dynamics, consequently leading to major control difficulties.

Therefore, a major disadvantage of this type of robot lies in the loss of the precision level during large load displacements controlled by variable inertia and coupling of the controls.

### SUMMARY

An embodiment of the disclosure is directed to a robot of the type including a base element and a mobile element coupled to said base element by movement control means, characterised in that said movement control means comprise a first and a second sub-assembly, said first sub-assembly being designed to move said mobile element along an approximately vertical direction, said second sub-assembly connecting said first sub-assembly to said mobile element and including at least three actuators capable of acting in parallel to move said mobile element in an approximately horizontal plane independently of said first sub-assembly.

An embodiment is directed to a robot including a base element, a mobile element, and a movement control assembly, which couples the mobile element to said base element. The movement control assembly includes a first and a second sub-assembly. Said first sub-assembly is designed to move said mobile element along an approximately vertical direction. Said second sub-assembly connects said first sub-assembly to said mobile element and includes at least three actuators capable of acting in parallel to move said mobile element in an approximately horizontal plane independently of said first sub-assembly.

A parallel robot according to an embodiment of the invention has many advantages.

One of the main advantages of this robot is that movements in the horizontal planes and along the vertical axis are decoupled due to the presence of the first and second sub-assemblies.

Decoupling of movements causes decoupling of powers.

It is known that a large amount of energy has to be expended to lift a load, because the force of gravity is in the same direction as the displacement. However, a much smaller amount of energy is expended to move the same load along the horizontal plane, because the force of gravity is perpendicular to the displacement. Therefore, an embodiment of the invention introduces motors with a capacity adapted to the displacement considered into the construction of the robot, for example a powerful motor to lift a load to a given altitude, and less powerful but much more precise motors to perform manipulations in the horizontal plane.

Therefore, it can be understood that an embodiment of the invention can be used to create high load capacity robots performing precise displacements.

Furthermore, decoupling of movements simplifies control of the robot to the extent that execution of the vertical displacement enables a linear input -output relation.

Furthermore, as will become clearer in the following, an embodiment of the invention makes it possible to proportionally copy the vertical movement with a similarity factor, so that the robot according to an embodiment of the invention can be used to make micro-mechanical systems (high precision systems).

Furthermore, as will become clearer after reading the following, each of the three mechanical actuators is composed of a system with a plane closed kinematic chain acting in parallel, such that the mobile element always remains parallel to the base element. This architecture assures an increase in the stiffness of the overall mechanics that is very helpful in obtaining better positioning precision of the mobile element. Thus, the mobile element can no longer have a horizontal inclination error if the elements making up the closed kinematic chains are geometrically perfect.

A robot with such a design is also advantageous in that it has a mechanical architecture that can be made at low cost, particularly because this architecture may be composed of standard construction elements.

According to a first embodiment, said first sub-assembly includes a support for each of said actuators, said supports being coupled to first motor means common to each of said supports.

Thus, the robot is displaced along a vertical axis by a single motor, which 5 makes the robot design very simple and prevents the need for synchronising several motors for this displacement.

According to a second embodiment, said first sub-assembly comprises a support coupled to motor means specific to it, for each of said actuators.

Thus, the number of degree of freedom of the manipulator is increased up lo to six.

According to one advantageous solution, said first motor means are carried by said base element.

In this way, these motor means are carried by a fixed element and do not form a load that could reduce the robot precision, particularly when the robot is manipulating lightweight parts.

Therefore, it will be understood that the robot thus designed is adapted both to manipulation of large loads and small parts.

Advantageously, each support is guided in translation on said base element.

Preferably, said motor means comprise at least one hydraulic jack.

Such a jack makes the robot able to transport relatively large loads without reducing its precision, since the jack itself is not a load to be displaced.

However, other kinematically equivalent systems, for example linear electric motors, can be used in other possible embodiments.

According to one preferred solution, the robot comprises a secondary support for each actuator mounted free to rotate on said base element.

According to a first variant, a secondary motor means may be associated with each secondary support to drive this secondary support.

According to another characteristic, each actuator comprises a set of bars articulated with each other so as to form a pantograph.

In this way, the input / output relation is achieved using a linear function, this function having a constant coefficient that is the similarity factor of the pantograph.

Such a pantograph structure provides a system for copying displacements of the first sub-assembly allowing large displacements or micro displacements at the output.

According to one advantageous solution, each said secondary support has a translational guide means of an element carried by one of said bars of one of said pantographs.

In this case, each said secondary support preferably has a slide in which a roller carried by one of said bars of one of said pantographs is free to slide.

According to a second variant, the device includes a secondary motor means associated with each translational guide means (instead of the motor means associated with each secondary support as described above).

Other solutions may be envisaged for translational guidance on supports, for example by making a slide cooperate with a ball bearing, or by displacing a carriage on a rail, etc.

Furthermore, the pantograph may be replaced by another equivalent mechanical system so that the movement can be copied.

Preferably, said motor means associated with each secondary support comprises an electric motor.

Such motors have relatively low power but they can be used to execute movements with high precision.

Decoupling of vertical and horizontal movements using the principle according to an embodiment of the invention enables the use of such motors provided that they act on loads moved horizontally that involve low energy expenditures compared with energy expenditures related to vertical displacements.

Obviously, other motor driven actuators can be envisaged without departing from the scope of the invention.

This avoids the need for synchronization of controls.

Furthermore, actuators operating with distinct energy sources can be managed, these motors possibly having different response times.

Other special features and advantages will become clearer after reading the following description of a preferred embodiment of the invention given as an illustrative and non-limitative example.

### BRIEF DESCRIPTION OF THE DRAWINGS

FIG. 1 shows a perspective view of a robot according to a first embodiment of the invention.

FIG. 2 shows a kinematic view of a robot according to the embodiment shown in FIG. 1.

FIG. 3 shows a kinematic view of a robot according to a second embodiment of the invention.

FIG. 4 shows a perspective view of a robot according to a third embodiment.

### DETAILED DESCRIPTION OF ILLUSTRATIVE EMBODIMENTS

As already mentioned, the principle of an embodiment of the invention is in the fact of defining decoupling of means in a parallel type robot for assuring vertical displacements of the means assuring horizontal displacements.

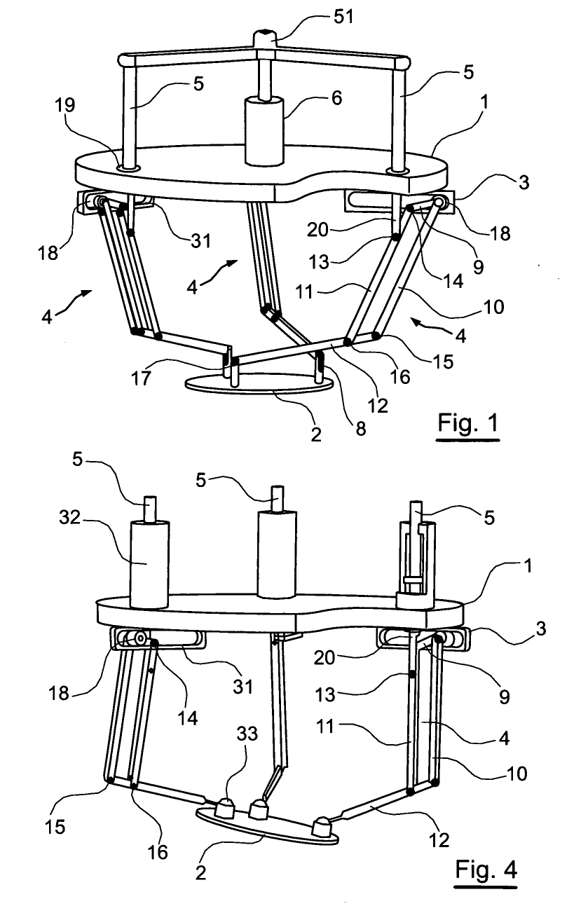

With reference to FIGS. 1 and 2 relating to a first embodiment of this invention, a parallel robot comprises a base element 1, a mobile element 2 connected to the base element by movement control means composed of kinematic systems described in detail below.

According to the principle of an embodiment of the invention, these movement control means comprise:
a first sub-assembly 5, 6 designed to replace the element 2 that is mobile in the vertical direction,
a second sub-assembly connecting the first sub-assembly to the mobile element 2 and including three actuators 4 that can act in parallel to move the mobile element 2 horizontally, independently of the first sub-assembly.

As shown in FIG. 1, the first sub-assembly comprises three supports 5 extending vertically and each connected firstly to an actuator 4, and secondly to a cross piece 51 coupled to electrical motor means 6 (note that these motor means could comprise a hydraulic jack in another embodiment).

As can be seen in FIG. 2, the base element 1 supports three rotating modules 21 each designed to drive a secondary support 3 mounted on the base element 1 in rotation, through an articulation 19. Each of these rotating modules 21 includes an electric motor.

It will be noted that each articulation 19 forms a pivot link of a secondary support 3 with respect to the base element 1, and also a vertical translation guide means of a support 5 on the base element 1.

Each secondary support 3 is fixed in rotation to a mechanical actuator 4 that is installed through a pivoting connection 52 firstly onto the support 5, and secondly through an articulation 8 onto the mobile element 2.

As illustrated in FIG. 1, each mechanical actuator 4 includes a pantograph mechanism composed of bars 9, 10, 11 and 12 connected to each other through articulations 13, 14, 16, 17.

Each actuator 4 is fixed in rotation to the corresponding secondary support 3 through a roller 18, this roller being free to slide in a groove 31 in the secondary support 3 (such a link may be made also by a slide with a ball bearing or by another translation connection according to other possible embodiments).

Each roller 18 is installed at the intersection of the bars 9 and 10 of each pantograph mechanism, in other words at the articulation 13.

The three rotating modules 21 are connected through appropriate amplifiers to a control unit 22 (a computer or a logic controller) that will control rotational movements of the actuators 4 in the horizontal plane.

This control unit 22 is also connected to the motor 6 to control the motor.

Thus, the vertical movement of the motor 6 causes vertical movements of the support 5 that results in movement of the articulation 13. The vertical movement of the articulation 13 causes a vertical movement of the articulation 17 through the mechanical actuator 4.

The mechanical actuators made in the form of pantographs enable a relation between the input 6 and the output 2 in the form of a linear function with a constant coefficient that is the similarity factor of the pantograph.

Furthermore, rotations of the rotating modules 21 are transformed into rotations of secondary supports 3 that are transformed in turn through mechanical actuators 4, into movements of the mobile element 2 in the horizontal plane.

Note that the three degrees of freedom in the horizontal plane are broken down into two translations in perpendicular directions in the horizontal plane and in one rotation about a vertical axis.

It will be understood that blockage of the motor 6 fixes the altitude of the mobile element 2, which keeps the mobile element 2 in a horizontal plane during rotations of the actuators 4.

The only differences between the second embodiment shown diagrammatically in FIG. 3 and the embodiment described above with reference to FIGS. 1 and 2, are the position of the secondary support 3 and the roller 18 and the attachment point of the lower end of the support 5.

In this embodiment, the secondary support 3 and the roller 18 are provided on the bar 11 while the other lower end of the support 5 is installed free to pivot on the articulation 13.

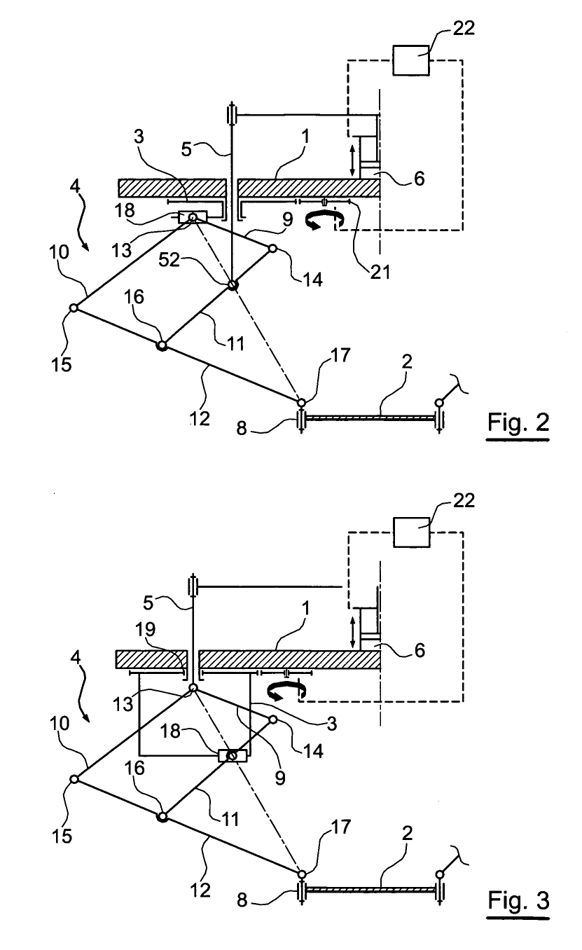

A third embodiment is shown in FIG. 4.

According to this third embodiment, each of the supports 5 is associated with a motor 32 that is specific to it. Furthermore, ball joints 33 are provided to connect the bars 12 of the pantograph mechanisms to the mobile element. Thus, the manipulating robot according to an embodiment of the invention has six degrees of freedom.

The three embodiments of the parallel robot described above have three arms showing:
a motor driven rotational link corresponding to the link between the base 1 and the support 3;
a passive prismatic link corresponding to the sliding link between the roller 18 and the secondary support 3;
a passive rotational link through the articulation 8 on the mobile element 2.

However, note that in other embodiments, the prismatic links rather than the rotational links can be motor driven, without departing from the scope of this invention.

The robot according to one or more embodiments of the invention may be used in a wide variety of application fields, particularly medical robotics in which apparatus has to be positioned with high precision (medical imagery, radiation generators, surgical instruments).

Other applications concern new machines, particularly machine tools with a high load capacity that have to execute very precise movements, particularly in the horizontal plane and along the vertical axis.

An embodiment proposes a parallel robot capable of executing displacements with a linear input/output relation.

An embodiment provides such a robot that is adapted to execution of relatively large movements and micro-displacements.

An embodiment provides such a robot that is capable of manipulating large loads, with high precision.

An embodiment provides such a robot that avoids the need to systematically synchronies the controls as is the case with prior art.

An embodiment provides a robot that is simple to design and to implement.

1. Robot comprising:
a base element;
a mobile element; and
a movement control assembly, which couples the mobile element to said base element by and comprises a first and a second sub-assembly, said first sub-assembly being designed to move said mobile element along an approximately vertical direction, said second sub-assembly connecting said first sub-assembly to said mobile element and including at least three actuators capable of acting in parallel to move said mobile element in an approximately horizontal plane independently of said first sub-assembly.

2. Robot set forth in claim 1, wherein said first sub-assembly includes a support for each of said actuators, said supports being coupled to a first motor common to each of said supports.

3. Robot set forth in claim 1, wherein said first sub-assembly includes a support coupled to a first motor specific to the support, for each of said actuators.

4. Robot set forth in claim 2, wherein said first motor is carried by said base element.

5. Robot set forth in claim 4, wherein said first motor, cooperates with said supports connected to said actuators and is installed free to slide on said base element.

6. Robot set forth in claim 1, and further comprising a secondary support mounted free to rotate on said base element, for each actuator.

7. Robot set forth in claim 6, and further comprising a secondary motor associated with each secondary support to drive this secondary support.

8. Robot set forth in claim 1, wherein each actuator includes a set of bars, articulated with each other so as to form a pantograph.

9. Robot set forth in claim 8, and further comprising a secondary support mounted free to rotate on said base element, for each actuator, and wherein each said secondary support has a translational guide of an element carried by one of said bars of one of said pantographs.

10. Robot set forth in claim 9, wherein each said secondary support has a slide in which a roller carried by one of said bars of one of said pantographs is free to slide.

11. Robot set forth in claim 9, and further comprising a secondary motor associated with each translational guide.

12. Robot set forth in claim 3, wherein said first motors are carried by said base element.

13. Robot set forth in claim 12, wherein said first motors, cooperate with said supports connected to said actuators and are installed free to slide on said base element.

14. A robot comprising:
a base element;
a mobile element; and
movement control means for coupling the mobile element to said base element, wherein the movement control means comprises a first and a second sub-assembly, said first sub-assembly being designed for moving said mobile element along an approximately vertical direction, said second sub-assembly connecting said first sub-assembly to said mobile element and including at least three actuators capable of acting in parallel for moving said mobile element in an approximately horizontal plane independently of said first sub-assembly.
